(19) United States
(12) Patent Application Publication
(10) Pub. No.: US 2009/0255477 A1
(43) Pub. Date: Oct. 15, 2009

(54) Animal waste management device

(76) Inventors: Curt R. FOURNIER, Linden, MI (US); Victoria D. JANUSZEWSKI, Linden, MI (US); Todd M. BRADFORD, Orrville, OH (US); John FLANNERY, Fenton, MI (US)

Correspondence Address: DOWELL & DOWELL P.C., 103 Oronoco St., Suite 220, Alexandria, VA, 22314, US

(21) Appl. No.: 12/385,168

(22) Filed: Mar. 31, 2009

Related U.S. Application Data
(63) Continuation-in-part of application No. 12/058,906, filed on Mar. 31, 2008.

(51) Int. Cl. A01K 29/00

(52) U.S. Cl. 119/161

(57) ABSTRACT

A pet waste management device includes a housing having upper and lower ends. The device includes a receiving bowl positioned in the housing, the bowl having an open upper end and a lower end having an outlet. A cover is situated upwardly adjacent the bowl upper end. A water outlet is positioned adjacent the bowl upper end to introduce water into the bowl. A supply line provides water to the water outlet. The device includes a first foot pedal configured to selectively allow water from the supply line to enter the bowl through the water outlet. A drain line is operatively coupled to the bowl lower end to drain contents of the bowl. The device includes a heating unit to prevent water from freezing, the heating unit including a resistive heating element and a thermostat and is in electrical communication with a power source.

This application is a continuation-in-part of U.S. patent application Ser. No. 12/058,906 which was filed on Mar. 31, 2008.

### BACKGROUND OF THE INVENTION

This invention relates generally to outdoor waste collection devices, and, more particularly, to an animal waste management device that may be installed at a residential or commercial property for the collection and disposal of animal waste.

The accumulation of pet waste in a residential yard or upon a commercial property is undesirable. In addition to being messy or malodorous, pet waste contains infectious disease, contaminants, and bacteria that may be harmful to people, marine animals, and, in general, to all wildlife. Contaminants from pet waste pollute waterways, including lakes, oceans, rivers, and streams.

Various devices have been proposed in the art for assisting in the collection and disposal of pet waste. Although assumably effective for their intended purposes, some of the existing proposals merely provide for assistive ways to collect pet waste. Other proposals have proposed depositing waste into a municipal sanitation system but fail to provide an effective apparatus to accomplish this. U.S. Pat. No. 6,453,844 shows a tray upon which the animal waste is deposited and a spray head to move the waste to an outlet. This arrangement however does not effectively flush the waste and leaves the tray surface exposed.

U.S. Pat. No. 6,792,628 shows a waste collection device with a lid. However, there is no provision for introducing water to the device except from a bucket.

U.S. Pat. No. 5,070,820 shows a bowl with a pair of nozzles to flush waste. However, no provision is made for proper connection to a server or for maintaining a sanitary condition of the receptacle.

It is therefore an object of the present invention to obviate or mitigate the above disadvantages.

### SUMMARY OF THE INVENTION

An animal waste management device is provided comprising a housing configured to have an upper end generally adjacent a ground surface. A receiving bowl is positioned in the housing and the bowl has upper and lower ends, the upper end being open, the lower end having an outlet. A lid upwardly adjacent the bowl selectively covers the bowl upper end and a flushing mechanism within the housing is connected between a water supply and the bowl. A water outlet introduces water from the flushing mechanism into the bowl and a manual control controls operation of the lid and operates selectively the flushing mechanism to cause water to flow into the bowl and thereby flush waste in the bowl to the outlet.

Embodiments of the invention will now be described by way of example only with reference to the accompanying drawings in which:

### BRIEF DESCRIPTION OF THE DRAWINGS

FIG. 1 is a perspective view of a first embodiment of pet waste management device.

FIG. 2 is an exploded view of the pet waste management device as in FIG. 1.

FIG. 3 is a perspective view of the pet waste management device as in FIG. 2 with the upper end of the housing and cover removed.

FIG. 4a is a perspective view of the pet waste management system as in FIG. 1;

FIG. 4b is an isolated view on an enlarged scale of the portion within circle 4b, 4c in a first position.

FIG. 4c is an isolated view on an enlarged scale of the portion within circle 4b, 4c in a second position.

FIGS. 4d and 4e are isolated views on an enlarged scale of the portion within the circle 4d, 4e in alternative positions.

FIG. 5 is a front perspective view of a further embodiment in a closed position

FIG. 6 is a rear perspective view of the embodiment of FIG. 5

FIG. 7 is a view similar to FIG. 5 in an open position

FIG. 8 is an exploded perspective view of the components of the embodiment of FIG. 5

FIG. 9 is a top view of a housing used in the embodiment of FIG. 5

FIG. 10 is a top perspective view, similar to FIG. 9 with a portion of the components assembled,

FIG. 11 is a section on the line XI-XI of FIG. 5

FIG. 12 is a section on the line XII-XII of FIG. 11

FIG. 13 is a perspective view of the assembled components within the housing

FIG. 14 is a perspective view of an actuating mechanism used on the embodiment of FIG. 5

FIG. 15 is an exploded view of the components used in the mechanism of FIG. 14

FIG. 16 is a side view of a portion of the mechanism of FIG. 14 in a locked position

FIG. 17 is side view of the mechanism of FIG. 16 in an unlocked position, and

FIG. 18 is a side view of the mechanism of FIG. 16 in an operative position.

### DESCRIPTION OF THE PREFERRED EMBODIMENT

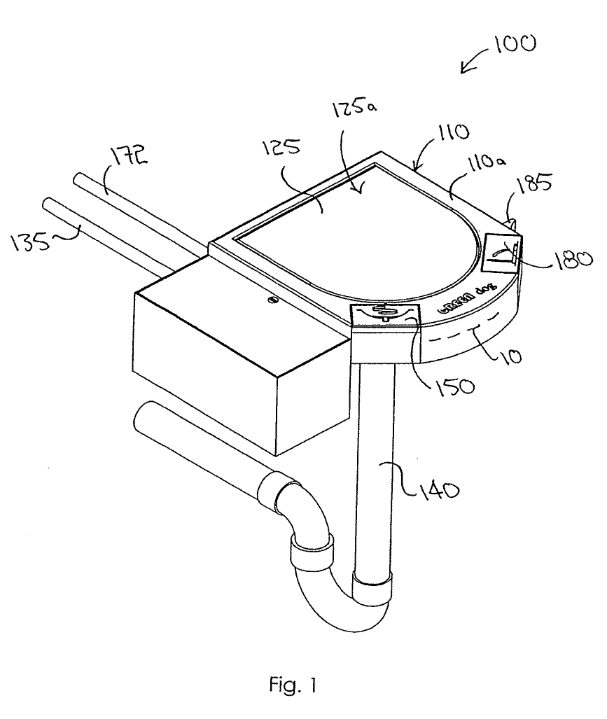

An animal waste management device will now be described in detail with reference to FIG. 1 through FIG. 4e of the accompanying drawings. More particularly, the animal waste management device 100 includes a housing 110 and a receiving bowl 120.

As shown in FIG. 1, the housing 110 is configured to have an upper end 10a that is generally adjacent a ground surface 10. In being generally adjacent to the ground surface 10, the upper end 110a may or may not be flush with the ground surface 10. The housing 110 may be constructed of stainless steel, plastic, concrete, or any other appropriate material.

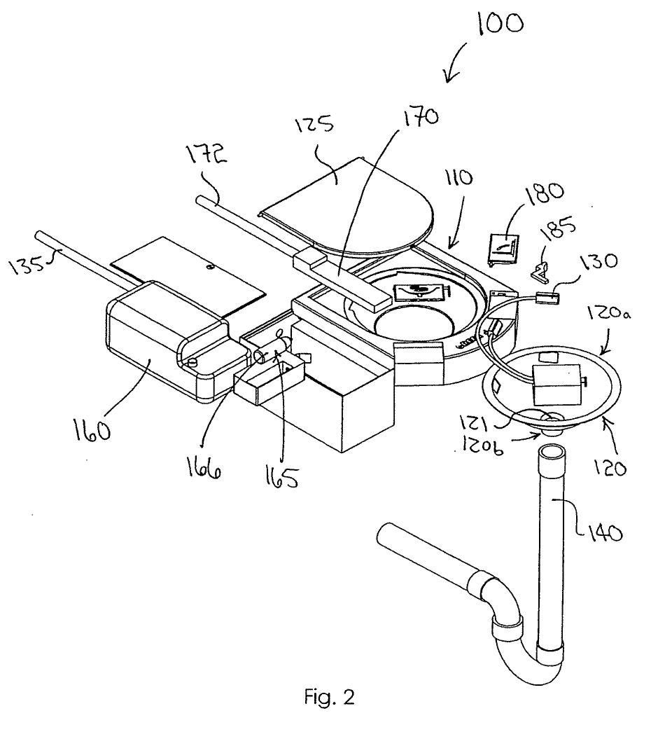

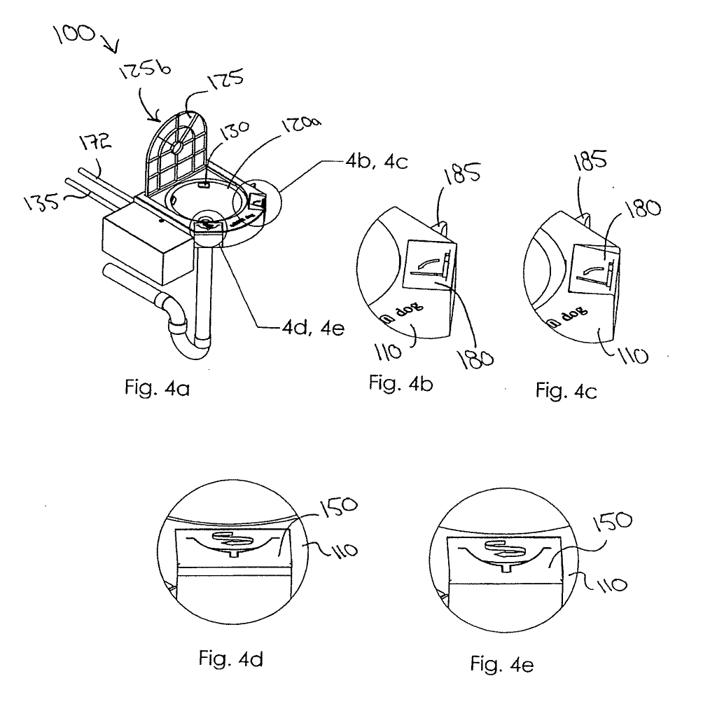

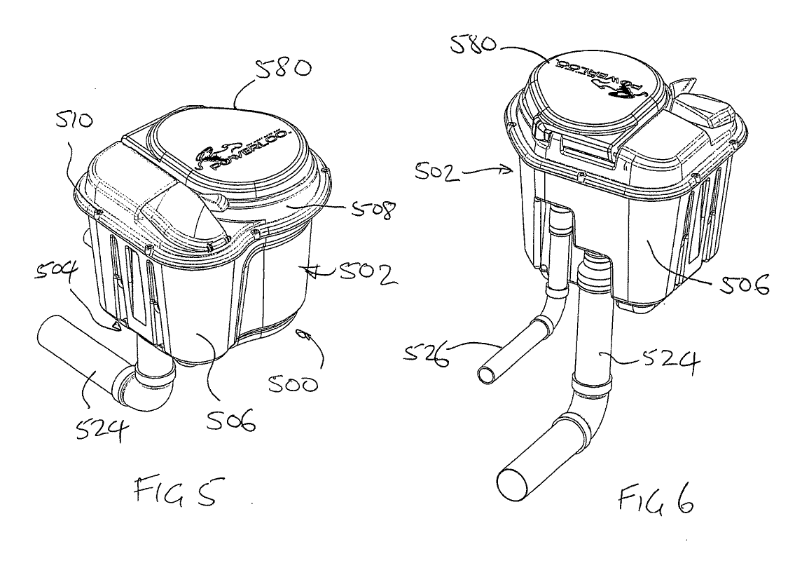

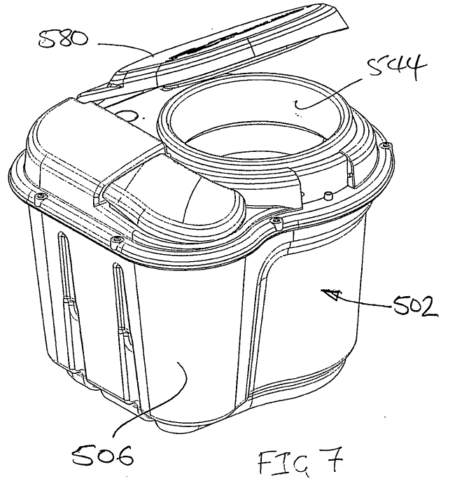

The receiving bowl 120 has upper and lower ends 120a, 120b (FIG. 2) and is positioned in the housing 110 (FIG. 4a). The upper end 120a is open, and the lower end 120b has an outlet 121. The bowl 120 may be constructed of stainless steel, plastic, or any other appropriate material.

A cover 125 is upwardly adjacent the bowl 120 to selectively cover the bowl upper end 120a. The cover 125 may be movable between a lowered position 125a (FIG. 1) and a raised position 125b (FIG. 4a). Access to the bowl 120 (i.e., the bowl upper end 120a) may be restricted when the cover 125 is at the lowered position 125a (FIG. 1), and the bowl 120 may be accessed when the cover 125 is at the raised position 125b (FIG. 4a). The cover 125 may be a biased toward the raised position 125b due to a spring or other biasing element. The cover 125 includes a seal to provide a watertight connection with the housing 110 and/or the bowl 120 so that drainage water and other materials cannot enter the bowl 120 when the cover 125 is at the lowered position 125a.

A water outlet 130 is adjacent the bowl upper end 120a (FIG. 4a) to introduce water into the bowl 120, and a supply line 135 (FIG. 4a) is in communication with the water outlet 130 to provide water to the water outlet 130. A drain line 140 is operatively coupled to the bowl lower end 120b to drain contents of the bowl 120. A user input (e.g., foot pedal 150) is configured to selectively allow water from the supply line 135 to enter the bowl 120 through the water outlet 130. As shown in FIGS. 4d and 4e, the foot pedal 150 is biased by a spring or other biasing element to return to the initial position (FIG. 4d) after being actuated (FIG. 4e).

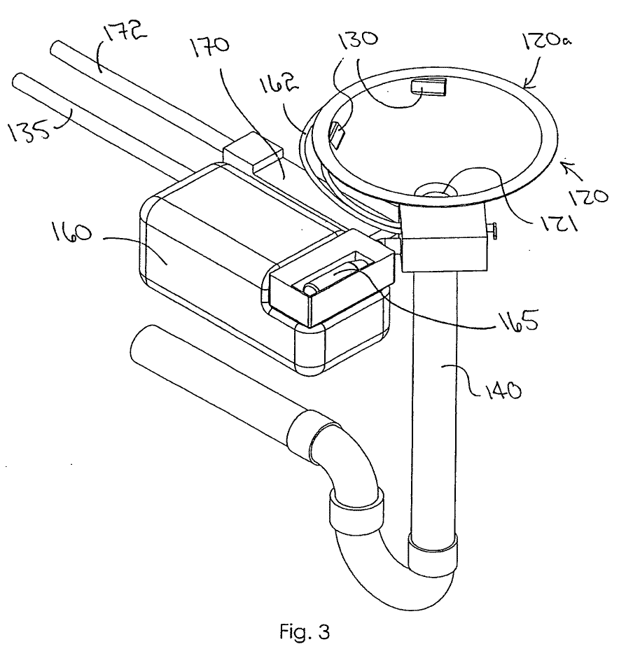

A pressure-assist unit 160 (FIG. 2) is located between the supply line 135 and the water outlet 130 to increase pressure of water obtained from the supply line 135 and selectively provide the water having increased pressure to the water outlet 130. As shown in FIG. 3, tubing 162 operatively couples the pressure-assist unit 160 to the water outlet 130. The foot pedal 150 is connected to the pressure-assist unit 160 to selectively cause the pressure-assist unit 160 to provide the water having increased pressure to the water outlet 130. Various pressure-assist units 160 may be utilized. One such appropriate pressure-assist unit traps air as it fills with water and uses the pressure of the water supply line to compress the trapped air; the trapped air then increases the water pressure of the water exiting the unit. It is understood, however, that the unit may alternatively be implemented using a standard gravity feed water supply without the use of pressure.

As shown in FIG. 2, an antibacterial agent 165 may be in communication with the supply line 135 (e.g., in communication with the pressure-assist unit 160) so that water passing from the supply line 135 to the water outlet 130 mixes with the antibacterial agent. The antibacterial agent 165 may be housed in a removable or replaceable cartridge 166 or may otherwise be in communication with the supply line 135.

For cold climate installation, a heating unit 170 extends adjacent the pressure-assist unit 160, the supply line 135, and/or the tubing 162 to prevent water and other components from freezing, as shown in FIG. 3. The heating unit 170 is preferably a resistive heating element and a thermostat that are in electrical communication with a power source. For example, electrical lines 172 may place the heating unit 170 in communication with an alternating current power source (e.g., a 110-volt power source), or the heating unit 170 may be in electrical communication with a battery. The heating unit 170 may also be connected to a solar power source (not shown).

The heating unit 170 is preferably a self regulating heating cable, such as those available from Heat-Line Corporation of Carnarvon, Ontario. The heating effect is proportional to the difference between ambient and set temperature to offer economical heating.

As detailed in FIGS. 4b and 4c, a foot pedal 180 is in communication with the cover 125 to selectively move the cover 125 from the lowered position 125a to the raised position 125b. The foot pedal 180 is biased to return to an initial position (FIG. 4b) after being actuated (FIG. 4c) due to a spring or other biasing element. A lock mechanism 185 (e.g., a foot-activated sliding pin) may be used to restrict actuation of the foot pedal 180 so that the foot pedal 180 may only be actuated while the lock mechanism 185 is actuated. The pin may be moved from the position shown in FIG. 4b where the lock mechanism 185 restricts actuation of the foot pedal 180, to the position shown in FIG. 4c where the lock mechanism 185 allows the foot pedal 180 to be actuated. The lock mechanism 185 may be biased such as by a spring or other biasing element to the position shown in FIG. 4b so as to prevent actuation of the foot pedal 180.

In use, the housing 110 is installed so that the upper end 110 is generally adjacent the ground surface 10, the supply line 135 is coupled to a well or public water supply line, and the drain line 140 is coupled to a sewage system in accordance with applicable slope and plumbing requirements. Preferably, the drain line 140 is situated at approximately a 2% slope. To dispose of animal waste, a user may first use a foot to release the lock mechanism 185 and then press the foot pedal 180 (FIG. 4c), which causes the cover 125 to move to the raised position 125b (FIG. 4a). The waste may then be deposited in the bowl 120, and the user may then actuate the foot pedal 150 to cause water to flow through the water outlet 130 and move the waste down the drain line 140 to the sewage system. The lock mechanism 185 keeps the pedal 180 from being accidentally actuated and inhibits children from actuating the pedal 180.

Actuating the foot pedal 150 causes the pressure-assist unit 160 to provide the water having increased pressure to the water outlet 130. If the antibacterial agent 165 is included, water mixed with the antibacterial agent 165 passes through the water outlet 130 to sanitize the bowl 120. Heating unit 170 keeps water in the pressure-assist unit 160, the supply line 135, the tubing 162, and other components from freezing in cold climates and/or winter months. If the cover 125 is biased toward the raised position 125b, the user may use his foot to return the cover 125 to the lowered position 125a.

The watertight seal between the cover 125 and the housing 110 and/or the bowl 120 when at the lowered position 125a inhibits drainage water and other materials from entering the bowl 120 when the cover 125 is at the lowered position 125a. If desired, a backflow valve may be incorporated in the animal waste management device 100.

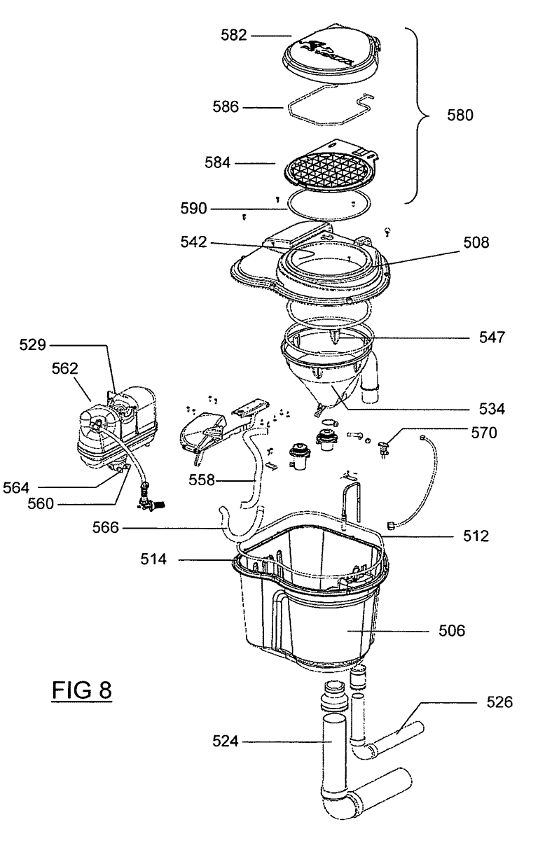

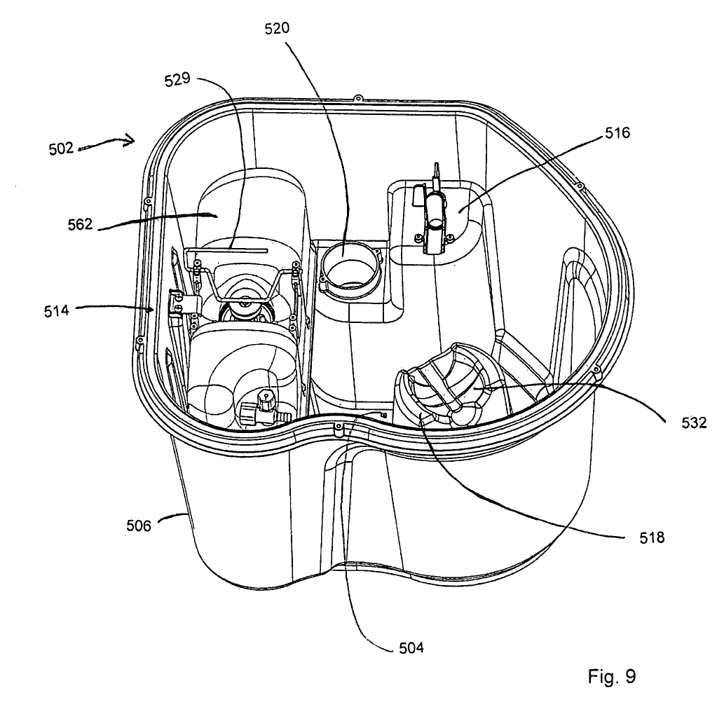

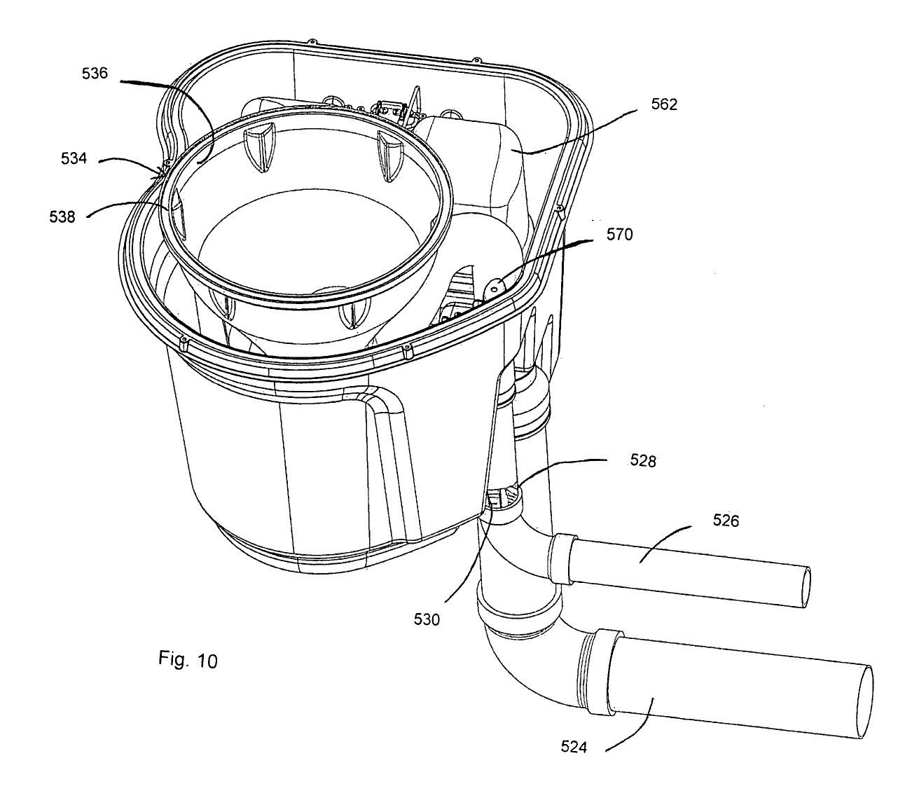

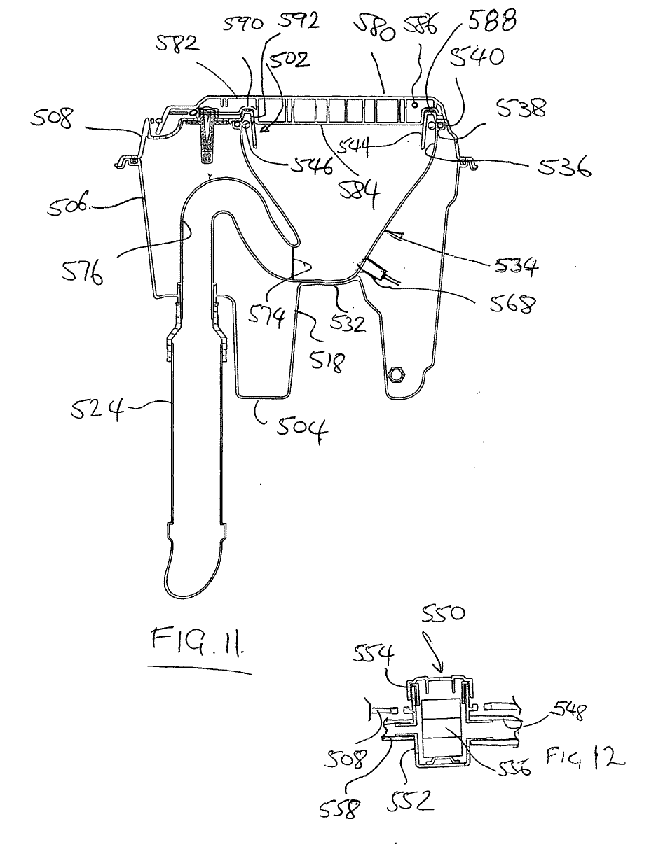

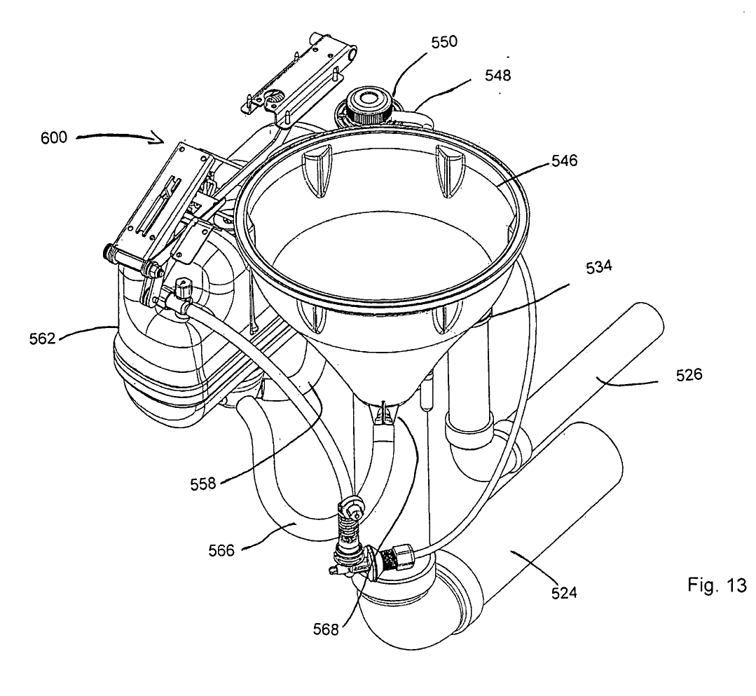

A further embodiment of the device is shown in FIGS. 5 through 18. The waste management device 500 includes a housing 502 with a base 504 and sidewalls 506. A cover 508 is attached to the upper edge of the sidewalls 506 by screws 510. An O-ring 512 is located in a groove 514 (FIGS. 8 and 9) to seal between the cover 508 and the sidewalls 506.

As can most clearly be seen in FIG. 9, the base 504 is formed with a pair of pedestals 516, 518. The pedestal 516 has a pair of apertures 520, 522 to allow services to be connected to the interior of the housing 502. The aperture 520 is sized to receive a sanitary waste pipe 524 (FIGS. 5 and 8) and the apertures 522 receive a service conduit 526 that contains a flexible water supply pipe 528 and a self regulating heater cable 530. The waste pipe 524 is connected to a sanitary sewer system in a conventional manner.

The pedestal 518 has a concave upper surface 532 to support a lower end of a bowl 534. The bowl 534 is generally conical tapering from the open upper end 536. The upper end 536 is formed with a rim 538 having a groove to receive a sealing ring 540.

As best seen in FIG. 11, the bowl 534 is held in place by the cover 508 which seals against the sealing ring 540. The cover 508 has a circular opening 542 with a downwardly projecting flange 544. The flange 544 overlaps the upper end 536 of a bowl 534 and a spray ring 546 is located between the flange and the upper end of the bowl. The spray ring 546 is located on ribs 547 provided on bowl 534 and connected by a hose 548 (FIG. 13) to a sanitizer dispenser 550. As can be seen in FIG. 12, the dispenser 550 is secured to the cover 508 and has a cylindrical housing 552. The housing 552 projects above the cover and has a removable cap 554 to permit sanitizer tablets 556 to be located within the housing 552. Water is supplied to the dispenser 550 through a hose 558 (FIGS. 8 and 13) that, in turn, is connected to an outlet 560 of pressure assist unit 562. The pressure assist unit 562 has a further outlet 564 that is connected by a hose 566 to a nozzle 568 located at the lower end of the bowl 534. As seen in FIG. 9, the pressure assist unit 568 is supported on the side wall 506 of the housing 502 and receives a supply of water from the water pipe 528 through a shut off valve 570. The pressure assist unit 568 is a commercial unit available from Sloan under the trade name Flowmate and includes a pair of check valves 572 to inhibit intermingling of fresh and grey water. The shut off valve 560 is accessible by removing the cover 508 to expose the valve 560 that is conveniently located above the pedestal 516.

Referring again to FIGS. 11 and 13, the bowl 534 has a waste outlet 574 positioned opposite the nozzle 568. The waste outlet 574 is connected to an S-bend 576 that extends from the outlet 574 to the aperture 520. The S-bend 576 is dimensioned to be compatible with standard fittings for connection to the sanitary waste pipe 524, and provides a water trap to prevent sewer gas from entering the bowl from the waste pipe 524.

The cover 508 supports a lid 580 that is pivoted to the cover 508. The lid 580 is formed with upper and lower plates 582, 584 respectively with a metal reinforcing hoop 586 located between the plates. The lower plate 584 has a raised recess 588 and carries a neoprene or other suitable material seal 590 at the base of the recess 588. The recess 588 is dimensioned to receive an upstanding edge 592 formed around the opening 542 that engages the neoprene seal 590 to form a tongue and groove connection that is an effective water repellent seal between the lid and the cover.

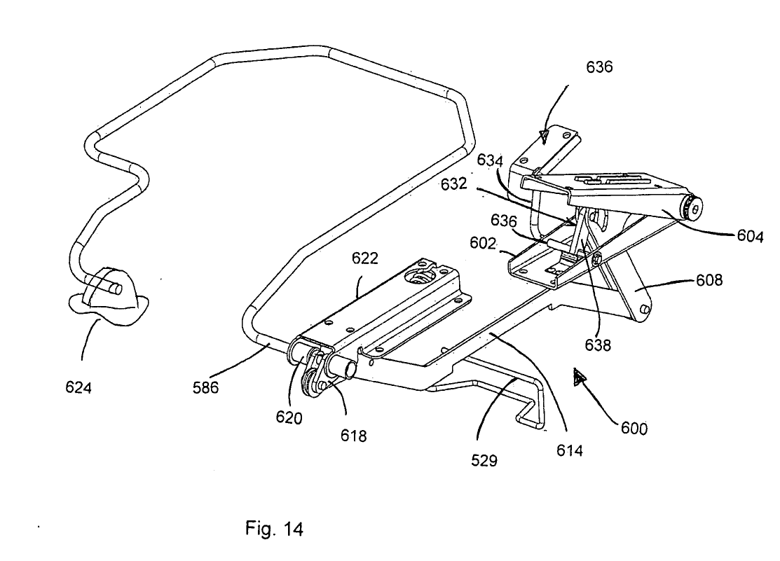

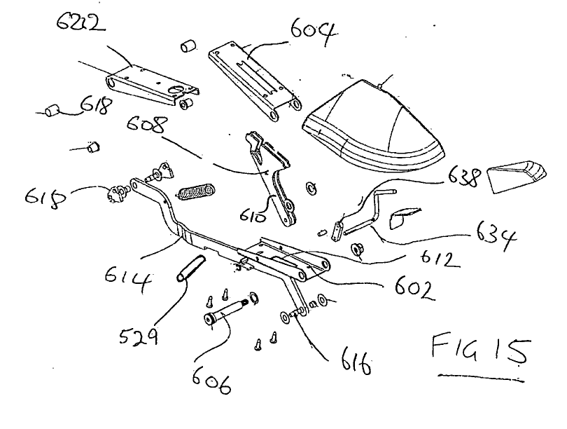

The lid 580 is connected to an operating mechanism 600, the details of which are shown in FIGS. 14 and 15. The mechanism 600 includes a pedal support plate 602 that is secured to the cover 508. A pedal 604 is pivotally connected to the plate 602 by pin 606 so it is free to swing through a limited vertical arc. An arm 608 formed by a pair of spaced plates 610 depends from the pedal 604 and passes through a slot 612 in the support plate 602. The lower end of the arm 608 is pivotally connected to an actuating rod 614 by a pivot pin 616. The rod 614 passes between the plates 610 and its distal end is connected to crank arms 618. The arms 618 are rigidly connected to bushes 620 that in turn are connected to a mounting plate 622. The plate 622 is bolted to the underside of lid 580 and the ends of the hoop 586 are received in the bushes after passing through pivot blocks 624 provided on the cover 508. A spring 626 acts between the plate 622 and the rod 614 to provide a return bias.

The arm 614 has a notch 628 located on its underside and a trip lever 629 is located within the notch 628. The trip lever 629 is connected to the pressure assist unit 562 (FIG. 8) to actuate the unit.

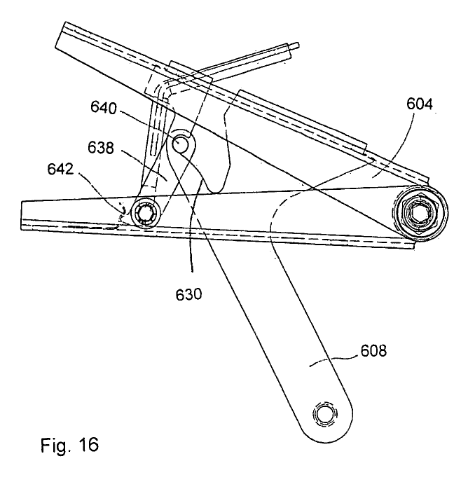

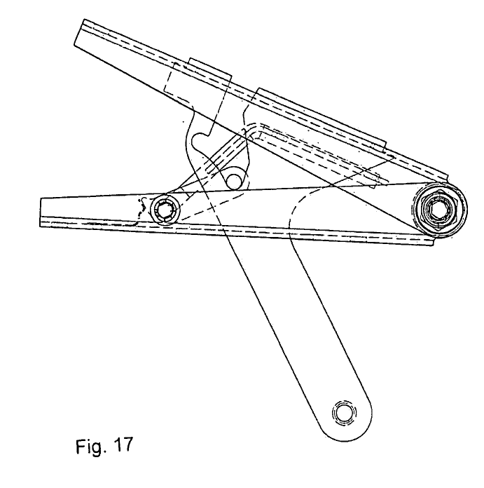

The arm 608 also has a cam 630 adjacent the plate 604 to provide a locking mechanism 632 shown in greater detail in FIGS. 16 to 18. The locking mechanism 632 has a locking lever 634 with a mounting flange 635 at one end. The lever 634 is generally L-shaped and passes through holes 636 formed in the upturned edges of the support plate 602. A keeper 638 is secured to the lever 634 and is located between the plates 610 of arm 608. A pin 640 extends transversely from the keeper 638 to engage the cam 630. An overcentre spring 642 acts between the lower end of the keeper 638 and the support plate to bias the keeper to one of two opposite directions.

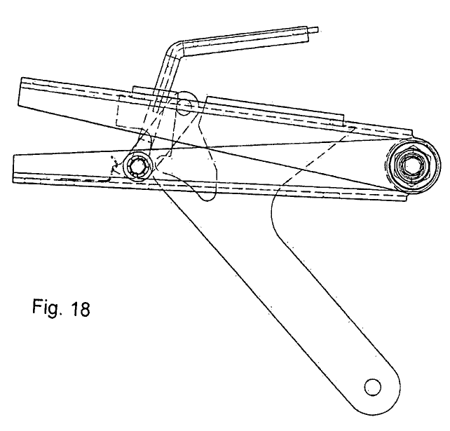

As can be seen in FIG. 16, the cam 630 has a generally diamond profile with a notch 644 at the rearward directed apex. The spring 642 biases the keeper 638 to hold the pin 640 in the notch 644 and thereby lock the actuating mechanism 600 by inhibiting movement of the pedal plate 604. Downward rotation of the lever 634 moves the spring 642 overcentre and pushes the pin to the opposite face of the cam 630, as shown in FIG. 17. In this position the pedal is free to pivot to move the rod 614 and lift the lid 580. Full depression of the pedal plate 604 moves the keeper 638 to the upper end of the cam 630 as shown in FIG. 18. In this position, the spring 642 is again moved overcentre to bias the pin in to the notch 640 as the pedal plate is released.

The unit 500 is installed within the ground by excavating a hole to receive the housing 502 and connection made to existing sanitary lines and electrical services supplied through the lines 524 and duct 526. The sanitary line 524 and service duct 526 are connected to the housing. The pressure assist unit 562 is then mounted to the wall 506 of the housing 502 and internal connections made to the water supply. The bowl 534 is located in the housing on the pedestal 518, the spray ring located on ribs 547 and the connections made from the unit 562 to the nozzle and the spray ring. The shut off valve 560 is opened to supply water to the unit 562, and the operation may be tested before the cover is attached. The cover 508, complete with the actuating mechanism 600 and the lid 580, is then assembled to the housing with the seal 540 located between the cover and the bowl. The flange 544 extends over the upper edge of the bowl to shield the spray ring. A latch pedal 644 is secured to the mounting flange 635 and a lid operating pedal 646 attached to the pedal support plate 604.

The lid 580 is locked in the closed position shown in FIG. 5 so that movement of the lid 580 inhibited. In this position, the interaction of the edge 590 in the recess 588 and the contouring of the cover 508 inhibit the flow of ground water in to the bowl 534. To deposit waste in to the bowl, the pedal 644 is depressed to release the locking mechanism 637. The action of the spring 642 maintains the pin 640 unlocked. The pedal 646 may then be depressed to move the actuating rod 614 to pivot the lid 580 to the position shown in FIG. 7. The bowl is then exposed to allow the waste to be deposited. Further depression of the pedal 646 causes the notch 628 to engage the trip lever 629 and operates the pressure assist unit to force water through the dispenser 550 to the spray ring 540. At the same time, water is delivered to the nozzle 568 to eject the waste to the outlet 574, through the S-bend and to the sanitary line 524. Release of the pedal after flushing allows the lid to return to the closed position and the latch to reset. The water retained in the bowl by the S-bend is maintained above freezing by the heater cable inclement weather conditions.

It will be seen therefore that an effective disposal of waste is attained and operation may be achieved through use of the foot, leaving the hands free to deposit the waste. The provision of the s-bend ensures that sewer gas cannot enter the unit, and the pressure assist unit provides effective cleansing, assisted by the sanitisation of the dispenser. for cold climates, the heating cable ensures that the water supply does not freeze and the unit remains functional.

1. An animal waste management device, comprising:
a housing configured to have an upper end generally adjacent a ground surface;
a receiving bowl positioned in said housing, said bowl having upper and lower ends, said upper end being open, said lower end having an outlet;
a lid upwardly adjacent said bowl to selectively cover said bowl upper end;
a flushing mechanism within said housing connected between a water supply and said bowl;
a water outlet to introduce water from said flushing mechanism into said bowl;
a manual control to control operation of said lid and to operate selectively said flushing mechanism to cause water to flow into said bowl and thereby flush waste in said bowl to said outlet.

2. The animal waste management device of claim 1, wherein tubing operatively couples said pressure-assist unit to said water outlet; and further comprising an electric heating unit extending adjacent at least one of said flushing mechanism, said supply line, and said tubing to prevent water from freezing; said heating unit including a resistive heating element.

3. The animal waste management device of claim 2, further comprising an sanitizing agent in communication with said pressure-assist unit, wherein water passing from said pressure-assist unit to said water outlet mixes with said sanitizing agent.

4. The animal waste management device of claim 1, wherein said manual control includes a foot pedal.

5. The animal waste management device of claim 4, wherein said manual control includes a lock mechanism to restrict actuation of said foot pedal, whereby said foot pedal may only be actuated while said lock mechanism is released.

6. The animal waste management device of claim 5 wherein release of said foot pedal resets said lock mechanism.

7. The animal waste management device of claim 6 wherein said foot pedal sequentially opens said lid and operates said flushing mechanism.

8. An animal waste management device, comprising:
a housing configured to have an upper end generally adjacent a ground surface;
a receiving bowl positioned in said housing, said bowl having upper and lower ends, said upper end being open, said lower end having an outlet;
a cover to locate said bowl within said housing;
a lid upwardly adjacent said bowl to selectively cover said bowl upper end, said cover being movable between a lowered position in which access to said bowl is restricted and a raised position in which said bowl may be accessed;
a water outlet to introduce water into said bowl;
a supply line to provide water to said water outlet;
a manual operator configured to selectively allow water from said supply line to enter said bowl through said water outlet; and
an outlet operatively coupled to said bowl lower end to connect said bowl to a drain.

9. The animal waste management device of claim 8, wherein water supply includes a first outlet adjacent an upper end of said bowl and a second outlet adjacent said outlets.

10. The animal waste management device of claim 8 wherein said water outlet includes a spray ring extending around the upper edge of said bowl.

11. The device of claim 10 wherein said cover includes a flange extending in to said bowl to cover said ring.

12. The device of claim 11 wherein said cover includes an upstanding edge extending around said bowl and said lid includes a recess to receive said edge.

13. The device of claim 12 wherein a seal is located between said edge and said recess.

14. The device of claim 12 wherein said cover is contoured to cause fluids to flow away from said upstanding edge.

15. The device of claim 8 wherein said bowl is supported in said housing and said cover locates said upper end within said housing.

16. The device of claim 15 wherein said cover includes a flange extending into said bowl.

17. The device of claim 16 wherein a seal is located between said upper end of said bowl and said cover.

18. The device of claim 8 wherein said manual operator is a foot pedal mounted on said cover and operable sequentially to move said lid to said raised position and to introduce water in to said bowl.

19. The device of claim 18 wherein a locking mechanism is provided to inhibit operation of said foot pedal.

20. The device of claim 19 wherein said locking mechanism is reset upon release of said foot pedal.
